(19) United States
(12) Patent Application Publication
(10) Pub. No.: US 2023/0327304 A1
(43) Pub. Date: Oct. 12, 2023

(54) BATTERY PACK

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Yusuke TAKASHI, Toyota-shi (JP); Kentaro SUZUKI, Kariya-shi (JP); Yuta NEMOTO, Okazaki-shi (JP); Hiroaki IKEDA, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/130,350

(22) Filed: Apr. 3, 2023

(30) Foreign Application Priority Data
Apr. 6, 2022 (JP) 2022-063272

(51) Int. Cl. H01M 50/593; H01M 50/209; H01M 50/186

(52) U.S. Cl. CPC H01M 50/593; H01M 50/209; H01M 50/186

(57) ABSTRACT

A battery pack includes battery cells and a spacer. Each battery cell includes an electrode body and a case accommodating the electrode body in a state sealed by a sealing portion. The battery cells are arranged in an arrangement direction. The spacer is arranged between the case of one of the battery cells and the case of an adjacent battery cell. The battery cells are bound together in a state in which a binding pressure is applied to the battery cells. The electrode body includes a flat portion. The spacer includes a base plate and projections projecting from the base plate toward the case of the adjacent battery cell. The projections include a top projection that presses the case of the adjacent battery cell at a position located upward from an upper edge of the flat portion where the sealing portion is the closest.

### BACKGROUND

### 1. Field

The present invention relates to a battery pack including battery cells and spacers arranged between the battery cells.

### 2. Description of Related Art

Battery packs of non-aqueous rechargeable batteries such as a lithium ion rechargeable batteries are often used as high-output power sources for driving vehicles or the like. In a battery pack, spacers are arranged between battery cells. Each battery cell includes a case accommodating an electrode body. Binding bands are used to bind the battery cells together. The binding bands apply a fixed load to the battery cells in the direction in which the battery cells are arranged next to one another. A sealing portion seals each battery cell with the electrode body accommodated in the case (refer to Japanese Laid-Open Patent Publication No. 2019-128991).

Each spacer includes protrusions, or projections, projecting toward a side wall of a case. The protrusions form a comb-tooth pattern on a base plate. The spacer presses the side wall of the adjacent case with the distal end surface of each protrusion. The open space between the protrusions define passages through which cooling air flows.

The case of each battery cell includes an opening. A lid, which defines the sealing portion, closes the opening with the electrode body accommodated in the case. Nevertheless, water may infiltrate through the sealing portion into the case over time. The water in the case may react with charge carriers, such as active material ions, at the upper edge of the electrode body near the sealing portion and extract the charge carriers from the active material. This will cause contraction of the active material that leads to contraction of an electrode. Such contraction will reduce the binding pressure applied by the spacer to the upper edge of the electrode body. Thus, the spacer will not be able to maintain the appropriate inter-electrode distance. This may decrease the capacity maintenance rate.

The protrusions of the spacers in Japanese Laid-Open Patent Publication No. 2019-128991 are elastically deformable in the arrangement direction of the battery cells. When the protrusions are elastically deformable in the arrangement direction, the binding force applied to the side wall of the case will be reduced at the portion corresponding to the upper edge of the electrode body. Thus, reaction of water with lithium ions in the case that cause contraction of the electrode will make it difficult to maintain the appropriate inter-electrode distance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a battery pack including battery cells, each including an electrode body and a case accommodating the electrode body in a state sealed by a sealing portion, the battery cells being arranged next to one another in an arrangement direction that is a single direction. The battery pack further includes a spacer arranged between one of two side walls of the case of one of the battery cells and one of two side walls of the case of an adjacent one of the battery cells. The battery cells are bound together in a state in which a binding pressure acting to force the battery cells toward each other is applied to the battery cells. The electrode body includes two opposing flat portions, each facing one of the side walls of the corresponding case. The spacer includes a base plate and projections projecting from the base plate toward one of the side walls of the case of the one of the adjacent battery cells. The projections include a top projection. The top projection presses the one of the side walls of the case of the one of the adjacent battery cells at a position located upward from an upper edge of each of the flat portions where the sealing portion is the closest.

In the above battery pack, the electrode body is a flattened roll formed by rolling a stack of a positive electrode sheet, a negative electrode sheet, and a separator. The flattened roll includes two opposing surfaces that define the two opposing surfaces. The flattened roll includes an upper curved portion bulged upward and connecting the upper edges of the two flat portions. The top projection presses the one of the side walls of the case of the one of the adjacent battery cells at a position corresponding to the upper curved portion.

In the above battery pack, the top projection extends continuously in a seamless manner in a direction parallel to the upper edges of the flat portions.

In the above battery pack, the projections are equal in height from the base plate.

In the above battery pack, when A represents a length of the side wall of the case between a first position corresponding to the upper edge of each of the flat portions and a second position corresponding to a lower edge of each of the flat portions and B represents a distance from the first position to a position pressed by the top projection near the first position, percentage C of B to A is 4.5% or greater and 13.6% or less.

Other features and aspects will be apparent from the following detailed description, the drawings, and the claims.

### BRIEF DESCRIPTION OF THE DRAWINGS

FIG. 1 is a perspective view of a battery pack.

FIG. 2 is a perspective view of a battery cell included in the battery pack of FIG. 1.

FIG. 3 is a cross-sectional view of an electrode body in an unrolled state.

FIG. 4 is a plan view of battery cells in a bound state.

FIG. 5 is a perspective view of spacers that are arranged between the battery cells.

FIG. 6 is a schematic diagram illustrating the positional relationship of a battery cell and a spacer.

FIG. 7 is a chart illustrating a manufacturing process of a battery cell used in examples and a comparative example.

FIG. 8 is a diagram illustrating the negative electrode plate resistance distribution in the comparative example.

FIG. 9 is a chart illustrating the average values of the negative electrode plate resistance at positions 1 to 4 in the comparative example.

FIG. 10 is a diagram illustrating the planar pressure distribution in example 1.

FIG. 11 is a chart illustrating the average values of the planar pressure at positions 1 to 4 in example 1 and the comparative example.

FIG. 12 is a graph illustrating the relationship of the number of cycles and the capacity maintenance rate in examples 1 to 3 and the comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

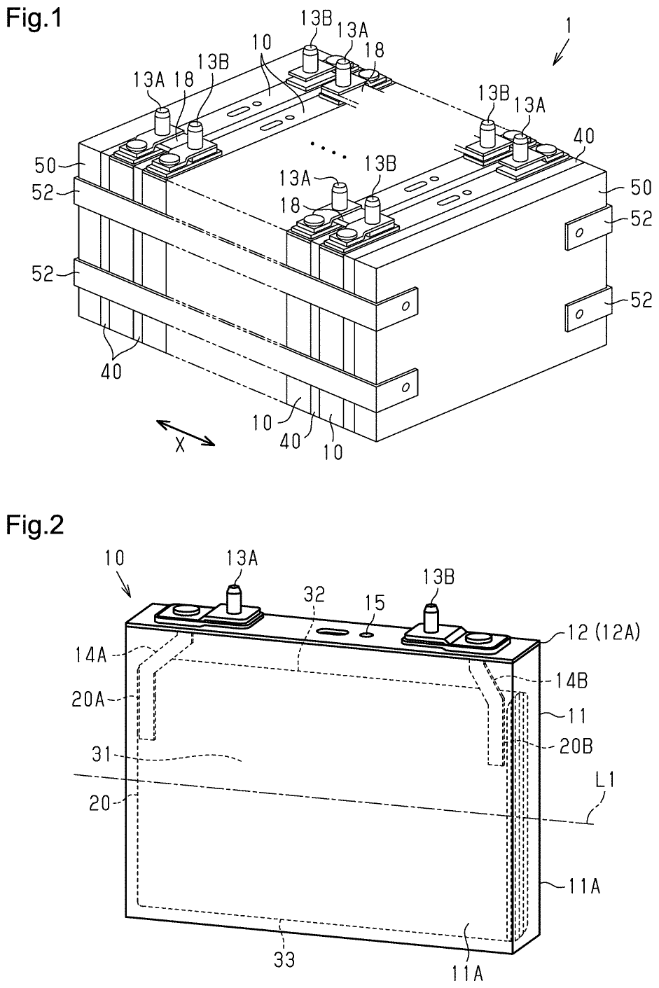

One embodiment in accordance with the present invention will now be described with reference to FIGS. 1 to 12.

Structure of Battery Pack

As shown in FIG. 1, a battery pack 1 includes battery cells 10, spacers 40, two end plates 50, and binding bands 52. The battery cells 10 are arranged next to one another in an arrangement direction X that is a single direction. The two end plates 50 are arranged at the two ends of the battery pack 1 in the arrangement direction X. The binding bands 52 are attached to the two end plates 50 so as to connect the two end plates 50. The spacers 40 are arranged in the arrangement direction X between adjacent battery cells 10 and between each end plate 50 and the adjacent battery cell 10.

The two end plates 50 sandwich the battery cells 10 and the spacers 40 in the arrangement direction X. The binding bands 52 are fastened by screws to the end plates 50. The binding bands 52 are attached to the two end plates 50 so as to apply a predetermined binding pressure in the arrangement direction X. This applies binding pressure to the battery cells 10 and the spacers 40 in the same direction as the arrangement direction X in order to force the battery cells 10 toward one another and integrally hold the battery pack 1. In the present embodiment, the two end plates 50 and the binding bands 52 define a binding mechanism.

Structure of Battery Cell

Referring to FIG. 2, in one example, the battery cell 10 is a lithium-ion rechargeable battery. Each battery cell 10 includes a case 11 and a lid 12. The case 11 accommodates an electrode body 20. The case 11 is box-shaped and has an open upper end. The lid 12 closes the opening of the case 11. The case 11 and the lid 12 are formed from a metal such as aluminum or an aluminum alloy. The case 11 has a thickness (plate thickness) of about 1 mm or less, preferably, 0.5 mm or less, for example, 0.3 mm or greater. In one example, the case 11 has a thickness (plate thickness) of 0.4 mm. The range may be set by combining the upper limit and lower limit described above in any manner. The battery cell 10 forms a sealed battery jar by attaching the lid 12 to the case 11. The case 11 includes two flat side walls 11A opposing each other in the arrangement direction X. When a spacer 40 applies binding pressure to a side wall 11A, the side wall 11A will deform slightly in an inward direction and thereby press the electrode body 20.

Two external terminals 13A and 13B are arranged on the lid 12. The external terminals 13A and 13B are used to charge and discharge electric power. A positive electrode collector portion 20A, which is the positive electrode end of the electrode body 20, is electrically connected by a positive electrode collector member 14A to the external terminal 13A of the positive electrode. A negative electrode collector portion 20B, which is the negative electrode end of the electrode body 20, is electrically connected by a negative electrode collector member 14B to an external terminal 13B of the negative electrode. The collector members 14A and 14B, which extend through the lid 12, are connected to the external terminals 13A and 13B, respectively. An insulative gasket is arranged between the lid 12 and the collector members 14A and 14B. The gasket electrically insulates the lid 12 from the collector members 14A and 14B and seals the gap between the lid 12 and the collector members 14A and 14B. The case 11 is filled with a non-aqueous electrolyte through an inlet 15. The external terminals 13A and 13B do not have to be shaped as shown in FIG. 2 and may have any shape. A bus bar 18 (refer to FIG. 1) electrically connects the positive electrode external terminal 13A of a battery cell 10 to the negative electrode external terminal 13B of an adjacent battery cell 10. This connects the adjacent battery cells 10 in series.

Electrode Body

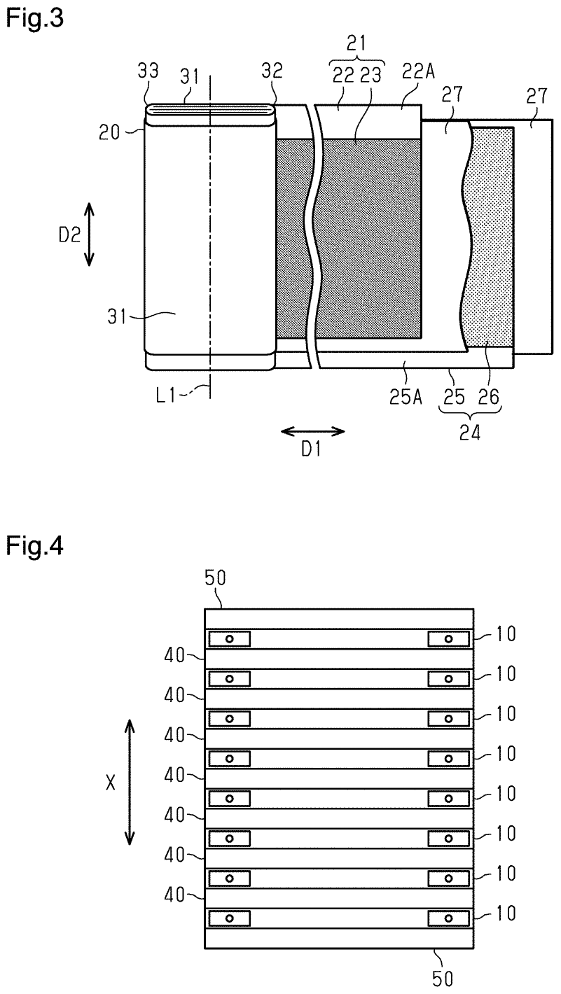

As shown in FIG. 3, the electrode body 20 is a flattened roll formed by rolling a stack of strips of a positive electrode sheet 21, a negative electrode sheet 24, and separators 27. The positive electrode sheet 21, the negative electrode sheet 24, and the separators 27 are stacked so that their long sides are parallel to a longitudinal direction D1. Prior to rolling, the positive electrode sheet 21, the separator 27, the negative electrode sheet 24, and the separator 27 are stacked in this order in a thickness direction. The electrode body 20 is structured by rolling the stack of the positive and negative electrode sheets 21 and 24 with the separators 27 held in between about a rolling axis L1 that extends in a widthwise direction D2 of the strips.

Positive Electrode Sheet

The positive electrode sheet 21 includes a positive electrode collector 22 and a positive electrode mixture layer 23. The positive electrode collector 22 is a strip of an electrode substrate foil. The positive electrode mixture layer 23 is applied to each of the opposing surfaces of the positive electrode collector 22. One end of the positive electrode collector 22 in the widthwise direction D2 includes a positive electrode uncoated portion 22A where the positive electrode mixture layer 23 is not formed and the positive electrode collector 22 is exposed.

The positive electrode collector 22 is a foil of a metal such as aluminum or an alloy of which the main component is aluminum. The positive electrode collector 22 functions as a collector of the positive electrode. In the roll, the opposing parts in the positive electrode uncoated portion 22A of the positive electrode collector 22 are pressed together to form the positive electrode collector portion 20A.

The positive electrode mixture layer 23 is formed by hardening a positive electrode mixture paste, which is in a liquid form. The positive electrode mixture paste includes a positive electrode active material, a positive electrode solvent, a positive electrode conductive material, and a positive electrode binder. The positive electrode mixture paste is dried and the positive electrode solvent is vaporized to form the positive electrode mixture layer 23. Accordingly, the positive electrode mixture layer 23 includes the positive electrode active material, the positive electrode conductive material, and the positive electrode binder.

The positive electrode active material is a lithium-containing composite metal oxide that allows for the storage and release of lithium ions, which serve as the charge carrier of the battery cell 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide is, for example, lithium cobalt oxide (LiCoO₂), lithium nickel oxide (LiNiO₂), or lithium manganese oxide (LiMn₂O₄). The lithium-containing composite metal oxide is, for example, a three-element lithium-containing composite metal oxide that contains nickel, cobalt, and manganese, that is, lithium nickel manganese cobalt oxide (LiNiCoMnO₂). The lithium-containing composite metal oxide is, for example, lithium iron phosphate (LiFePO₄).

The positive electrode solvent is an N-methyl-2-pyrrolidone (NMP) solvent, which is one example of an organic solvent. The positive electrode conductive material may be, for example, carbon black such as acetylene black or ketjen black, carbon nanotubes, carbon fiber such as carbon nanofiber, or graphite. One example of the positive electrode binder is a resin component included in the positive electrode mixture paste. The positive electrode binder is, for example, polyvinylidene fluoride (PVDF), polyvinyl alcohol (PVA), styrene-butadiene rubber (SBR), or the like.

The positive electrode sheet 21 may include an insulation layer at the boundary between the positive electrode uncoated portion 22A and the positive electrode mixture layer 23. The insulation layer includes an insulative inorganic component and a resin component that functions as a binder. The inorganic material is at least one selected from a group consisting of boehmite powder, titania, and alumina. The resin component is at least one selected from a group consisting of PVDF, PVA, and acrylyl.

Negative Electrode Sheet

The negative electrode sheet 24 includes a negative electrode collector 25 and a negative electrode mixture layer 26. The negative electrode collector 25 is a strip of an electrode substrate foil. The negative electrode mixture layer 26 is applied to each of the opposing surfaces of the negative electrode collector 25. One end of the negative electrode collector 25 in the widthwise direction D2 at the side opposite the positive electrode uncoated portion 22A includes a negative electrode uncoated portion 25A where the negative electrode mixture layer 26 is not formed and the negative electrode collector 25 is exposed.

The negative electrode collector 25 is a foil of a metal such as copper or an alloy of which the main component is copper. The negative electrode collector 25 functions as a collector of the negative electrode. In the roll, the opposing parts in the negative electrode uncoated portion 25A are pressed together to form the negative electrode collector portion 20B.

The negative electrode mixture layer 26 is formed by hardening a negative electrode mixture paste, which is in a liquid form. The negative electrode mixture paste includes a negative electrode active material, a negative electrode solvent, a negative electrode thickener, and a negative electrode binder. The negative electrode mixture paste is dried and the negative electrode solvent is vaporized to form the negative electrode mixture layer 26. Accordingly, the negative electrode mixture layer 26 includes the negative electrode active material and the additives of the negative electrode thickener and the negative electrode binder. The negative electrode mixture layer 26 may further include an additive such as a conductive material.

The negative electrode active material allows for the storage and release of lithium ions. The negative electrode active material is, for example, a carbon material such as graphite, hard carbon, soft carbon, or carbon nanotubes. One example of the negative electrode solvent is water. One example of the negative electrode thickener is carboxymethyl cellulose (CMC). The negative electrode binder may use the same material as the positive electrode binder. One example of the negative electrode binder is SBR.

Separator

The separators 27 prevents contact between the positive electrode sheet 21 and the negative electrode sheet 24 in addition to holding the non-aqueous electrolyte between the positive electrode sheet 21 and the negative electrode sheet 24. Immersion of the electrode body 20 in the non-aqueous electrolyte results in the non-aqueous electrolyte permeating each separator 27 from the ends toward the center.

Each separator 27 is a nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

Non-Aqueous Electrolyte

The non-aqueous electrolyte is a composition containing support salt in a non-aqueous solvent. The non-aqueous solvent is one or two or more selected from the group consisting of propylene carbonate, ethylene carbonate, diethyl carbonate, dimethyl carbonate, ethyl methyl carbonate, and the like. The support salt may be a lithium compound (lithium salt) of one or two or more selected from the group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt serving as an additive, is added to the non-aqueous electrolyte. For example, LiBOB is added to the non-aqueous electrolyte so that the concentration of LiBOB in the non-aqueous electrolyte is 0.001 mol/L or greater and 0.1 mol/L or less.

Stored State of Electrode Body

The electrode body 20 is arranged in the case 11 so that its rolling axis L1 extends parallel to the bottom surface of the case 11. Further, the electrode body 20, which has the form of a flattened roll, includes two opposing flat portions 31, an upper curved portion 32 connecting the upper edges of the flat portions 31, and a lower curved portion 33 connecting the lower edges of the flat portions 31. The upper curved portion 32 has an upwardly bulging shape, and the lower curved portion 33 has a downwardly bulging shape. The electrode body 20 is accommodated in the case 11 so that the lower curved portion 33 is located closer to the bottom surface of the case 11 and the upper curved portion 32 is located closer to the lid 12. The two flat portions 31 of the electrode body 20 in the case 11 oppose the two side walls 11A, respectively.

When the electrode body 20 is accommodated in the case 11, the lid 12 is arranged on the open end of the case 11 and then fixed to the open end through laser welding or the like to seal the opening of the case 11. The portion where the lid 12 is welded to the opening of the case 11 is one example of a sealing portion 12A (refer to FIG. 2) that seals the case 11. The gasket arranged between the lid 12 and the collector members 14A and 14B is one example of the sealing portion 12A. Then, the case 11 of the battery cell 10 is filled with electrolyte through the inlet 15 of the lid 12 (refer to FIG. 2). Afterwards, the inlet 15 is sealed through laser welding or the like. The portion where the inlet 15 is welded is one example of the sealing portion 12A. The upper curved portion 32 defines the upper edge of the electrode body 20 that is close to the sealing portion 12A.

Spacer

As shown in FIG. 4, the battery pack 1 includes a predetermined number of the battery cells 10 and the spacers 40 arranged between the battery cells 10. In the battery pack 1 of the present embodiment, the battery cells 10 sandwich the spacers 40 in the arrangement direction X between the parallel side walls 11A. The alternately arranged battery cells 10 and spacers 40 are sandwiched between the two end plates 50, which are located at the two ends in the arrangement direction X. The battery pack 1 of the present embodiment bundles the battery cells 10 using the spacers 40 and the end plates 50 as binding members. In one example, a planar pressure of 1 MPa or greater and 5 MPa or less is applied as a binding pressure to the side walls 11A of each battery cell 10. The applied pressure may be 2 MPa or greater and be approximately 3 MPa. The range may be set by combining the upper limit and lower limit described above in any manner.

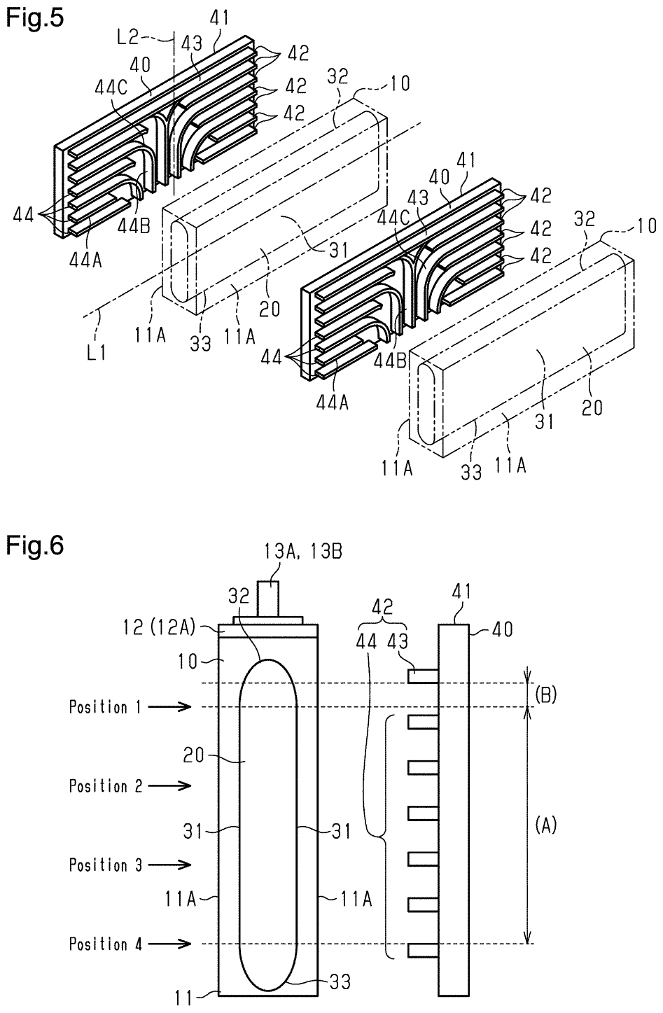

As shown in FIG. 5, each spacer 40 includes a base plate 41, which is a rectangular, and the projections 42, which project from one surface of the base plate 41. The other surface of the base plate 41 is pressed against the side wall 11A of the adjacent case 11. The projections 42 are rib-shaped and arranged in a comb-tooth pattern on the surface of the base plate 41. The projections 42 are equal in height from the surface of the base plate 41. Ventilation passages extend between the projections 42 to cool the battery cells 10. Each projection 42 includes an end surface that is flat to allow for planar contact with the corresponding side wall 11A. In one example, cooling air flows upward through the ventilation passages from the lower side.

The projections 42 include a first projection 43 that is a rib defining a top projection extending along the upper edge of the base plate 41 in the direction which the rolling axis L1 extends. In another example, the first projection 43, among the projections 42, may be a rib extending in the vicinity of the upper edge of the base plate 41 parallel to the upper edge of the base plate 41 in a direction in which the rolling axis L1 extends. The first projection 43 presses the side wall 11A above a position corresponding to the upper edges of the flat portions 31 of the electrode body 20. In other words, the first projection 43 presses the side wall 11A at a position corresponding to the upper curved portion 32 of the electrode body 20. The first projection 43 presses the upper curved portion 32 through the side wall 11A. The first projection 43 is a straight rib extending continuously in a seamless manner. In one example, the first projection 43 is the uppermost projection on the base plate 41.

The projections 42 other than the first projection 43 press the side wall 11A at positions mainly corresponding to the flat portion 31 of the electrode body 20 and define second projections 44, which mainly serve as flat portion projections. The second projections 44 include parallel portions 44A that are parallel to the rolling axis L1, vertical portions 44B that are orthogonal to the rolling axis L1, and connecting portions 44C connecting the parallel portions 44A and the vertical portions 44B.

The second projections 44 that are in the third row from the top and all other following second projections 44a that are in odd ordinal number rows are continuous ribs, in which the parallel portions 44A, the connecting portions 44C, and the vertical portions 44B are continuous. In the vertical portions 44B of the second projections 44 in the odd ordinal number rows, the lower parallel portions 44A are located farther from the center line L2. The second projections 44 in the even ordinal number rows are parallel portions 44A.

Operation of Battery Pack

As shown in FIG. 6, the projections 42 press the electrode body 20 with a predetermined binding pressure through the side wall 11A. This limits expansion of the electrode body 20. The projections 42 also function to maintain a constant inter-electrode distance in the electrode body 20. Most of the projections 42, that is, the second projections 44, press the side wall 11A at a position corresponding to the flat portion 31 of the electrode body 20. In contrast, the first projection 43 does not press the flat portion 31. Further, the gap between the side wall 11A and the upper curved portion 32 will incline the first projection 43. The load applied by the first projection 43 to the side wall 11A will be concentrated and thus press the side wall 11A with a higher planar pressure than the second projections 44. This increases the binding pressure at the pressed portion such that the displaced amount of the side wall 11A becomes greater than other regions.

A slight amount of water infiltrates the case 11 over time through the sealing portion 12A of the battery cell 10. The water will react with the lithium ions in the active material near the sealing portion 12A at the upper curved portion 32 and the nearby area. This will extract the lithium ions from the active material and cause contraction of the active material that leads to contraction of the electrode. Even in such a case, the first projection 43 will press the upper curved portion 32 through the side wall 11A with a binding pressure greater than that applied by the second projections 44. This allows the inter-electrode distance to be maintained. Thus, lithium precipitation will be reduced, and decrease in capacity maintenance rate will be limited.

### EXAMPLES

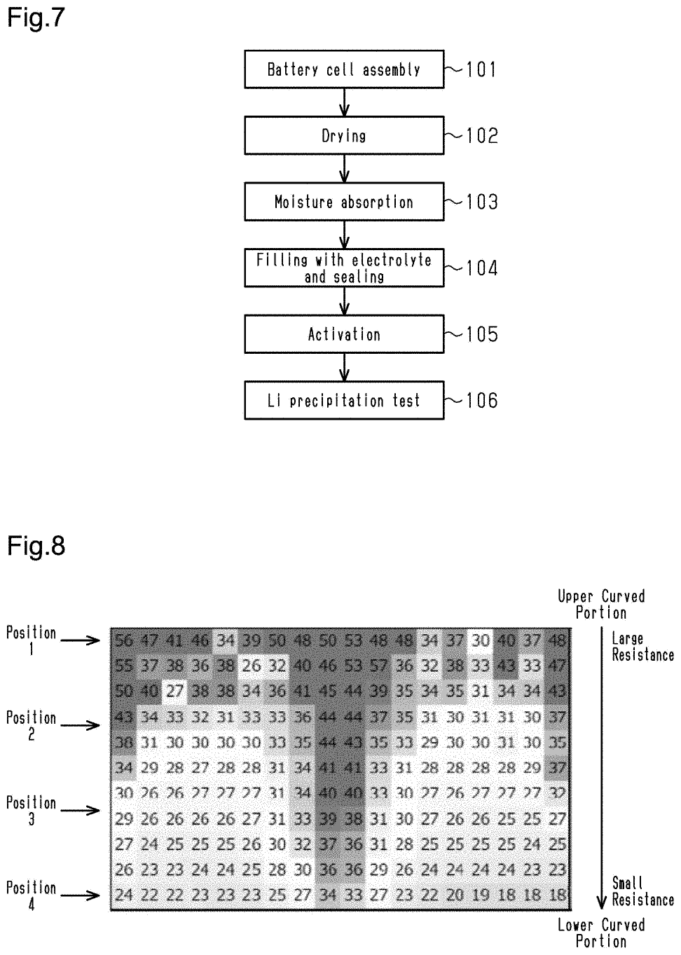

The battery cell 10 was manufactured as described below in examples. With reference to FIG. 7, in step 101, the battery cell 10 was assembled. More specifically, the positive and negative electrode sheets 21 and 24 were manufactured. The positive electrode sheet 21, the negative electrode sheet 24, and the separators 27 were then stacked and rolled. Further, the roll was pressed and flattened. Then, the positive electrode uncoated portion 22A was pressed to form the positive electrode collector portion 20A, and the negative electrode uncoated portion 25A was pressed to form the negative electrode collector portion 20B. These procedures manufactured the electrode body 20. Then, the electrode body 20 was arranged in the case 11. The positive electrode collector portion 20A was connected via the positive electrode collector member 14A to the positive electrode external terminal 13A. The negative electrode collector portion 20B was connected via the negative electrode collector member 14B to the negative electrode external terminal 13B. The open upper end of the case 11 was closed by the lid 12. The lid 12 used in the examples differs from the actual product and includes a through hole for experimental purposes. The through hole allows the atmosphere of the battery jar in the case 11 to be easily affected by the ambient environment.

Before closing the opening of the case 11 with the lid 12, sensors were arranged between the side wall 11A and the electrode body 20 to measure the pressure and the negative electrode resistance. These sensors cannot be stably arranged on the upper curved portion 32 and lower curved portion 33 of the electrode body 20. Thus, these sensors were arranged on the flat portion 31.

In step 102, the electrode body 20 was dried. In one example, the electrode body 20 was dried at 105° C. under a reduced-pressure atmosphere for one hour or longer. In step 103, moisture was absorbed from the electrode body 20. In one example, moisture was absorbed for twelve hours under an environment in which the temperature was 25° C. and the humidity was 65%.

In step 104, the case 11 was filled with a non-aqueous electrolyte through the inlet 15. Then, the inlet 15 was sealed. In step 105, the battery cell 10 of the example formed in this manner was initially charged and then activated. In step 106, a lithium precipitation test was conducted.

### Example 1

Referring to FIG. 6, in the flat portion 31, position 1 (first position) was defined at the upper edges of the flat portions 31, or the boundary of the flat portions 31 and the upper curved portion 32. Position 2 was defined at a location separated by a fixed interval from the position 1. Position 3 was defined at a location separated from position 2 by the fixed interval. Position 4 (second position) was defined at the lower edges of the flat portions 31, or the boundary of the flat portions 31 and the lower curved portion 33. The intervals are equal between positions 1 and 2, between positions 2 and 3, and between positions 3 and 4.

The distance between the upper edges of the flat portions 31 (position 1) and the lower edges of the flat portions 31 (position 4), or the height of the flat portion 31, is denoted by A. Further, the distance from the edges of the flat portions 31 (position 1) to the corner (edge) of the first projection 43 near position 1, or the distance from the first projection 43 to the flat portions 31, is denoted by B. In other words, B denotes the distanced amount of the first projection 43 from the upper edges of the flat portion 31. In example 1, percentage C of B to A, or the distance percentage C of the portion extending from position 1 toward the upper curved portion 32, was set to 13.6%.

### Example 2

In example 2, percentage C of B to A, or the distance percentage C of the portion extending from position 1 toward the upper curved portion 32, was set to 7.8%.

### Example 3

In example 3, percentage C of B to A, or the distance percentage C of the portion extending from position 1 toward the upper curved portion 32, was set to 4.5%.

### Comparative Example

In a comparative example, percentage C of B to A, or the distance percentage C of the portion extending from position 1 toward the upper curved portion 32, was set to −2.9%. Thus, the projections 42 were located only at positions corresponding to the flat portion 31 and not above the upper curved portion 32. In the comparative example, the spacer 40 did not include a rib that can be defined as the first projection 43.

In examples 1, 2, 3 and the comparative example, rolling of the stack of the positive electrode sheet 21, the negative electrode sheet 24, and the separators 27 increased the roll core diameter. This increased A and decreased B.

TABLE 1

| | | | Distance | |
|---|---|---|---|---|
| | | Electrode | from Top | |
| | | Body Flat | Projection | |
| | Roll Core | Portion | to Flat | Percentage |
| | Diameter | Height | Portion | (C) of (B) |
| | (mm) | (mm) (A) | (mm) (B) | to (A) (%) |
| Example 1 | 25.75 | 40.45 | 5.5 | 13.6 |
| Example 2 | 26.77 | 42.05 | 3.3 | 7.8 |
| Example 3 | 27.32 | 42.91 | 1.9 | 4.5 |
| Comparative | 29.40 | 46.18 | −1.3 | −2.9 |
| Example | | | | |

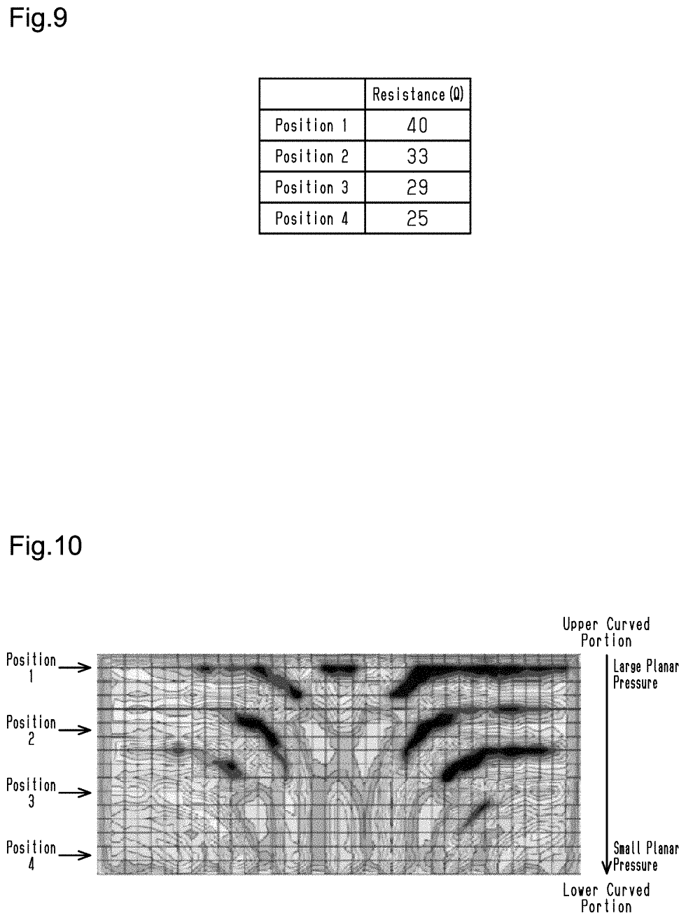

FIG. 8 is a diagram illustrating the negative electrode plate resistance distribution in the comparative example. In FIG. 8, the upper side corresponds to the upper curved portion 32, and the lower side corresponds to the lower curved portion 33. FIG. 9 is a chart illustrating the average values of the negative electrode plate resistance at positions 1 to 4. In FIG. 8, the darker regions indicate higher resistances.

In the comparative example, the negative electrode resistance around position 1 was higher than the negative electrode resistance at positions 2, 3, and 4 (refer to FIGS. 8 and 9). It is understood that such a situation is caused by the water that infiltrates the electrode body 20 through the sealing portion 12A. Continued usage will result in the reaction of water with charge carriers, such as ions in the active material. This will cause contraction of the active material that leads to contraction of the electrode body 20. Further, lithium precipitation will occur. A region where the negative electrode resistance is high extends vertically in the middle part with respect to the sideward direction. In this region, the high negative electrode resistance was not caused by the reaction of water with the upper curved portion 32.

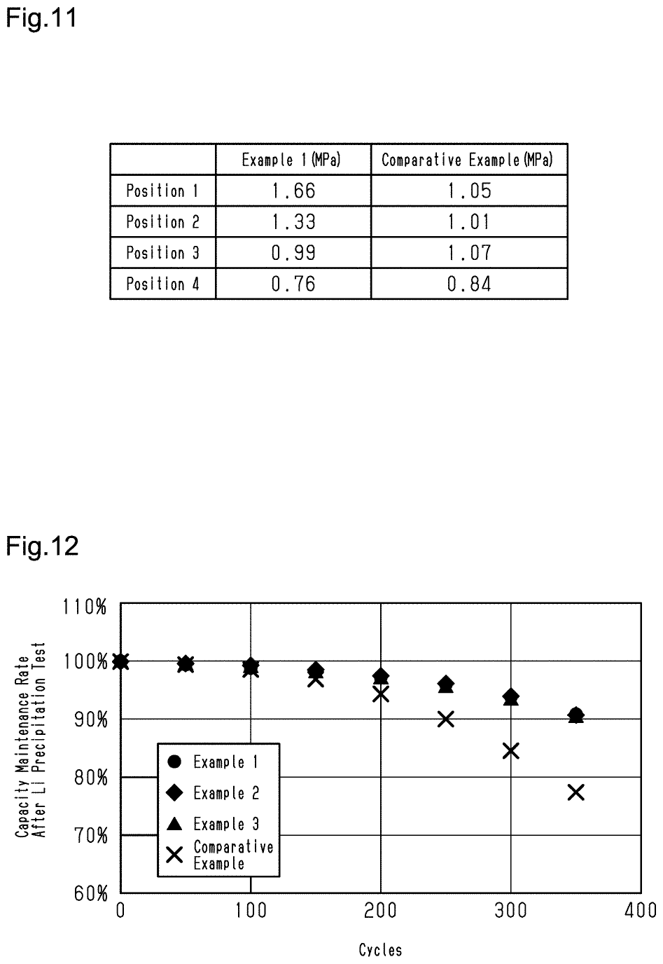

FIG. 10 is a diagram illustrating the planar pressure distribution of the binding pressure in example 1. In FIG. 10, the darker regions indicate higher pressures. FIG. 11 is a chart illustrating the average values of the binding pressure at positions 1, 2, 3, and 4 in example 1. In example 1, the spacer 40 includes the first projection 43. Thus, the binding pressure at position 1 was higher than that at positions 2, 3, and 4. As shown in FIG. 11, the comparative example does not include the first projection 43. Thus, the binding pressure at position 1 was lower than that in example 1. Further, in the comparative example, the binding pressure was substantially the same at positions 1 to 4.

TABLE 2

| | Number of Cycles [cyc] | | | | | | | |
|---|---|---|---|---|---|---|---|---|
| | 0 | 50 | 100 | 150 | 200 | 250 | 300 | 350 |
| | Charge Current Value [A] | | | | | | | |
| | 0 | 210 | 220 | 230 | 240 | 250 | 260 | 280 |
| | Capacity Maintenance Rate | | | | | | | |
| Example 1 | 100% | 100% | 99% | 98% | 97% | 96% | 94% | 91% |
| Example 2 | 100% | 100% | 99% | 99% | 98% | 96% | 94% | 91% |
| Example 3 | 100% | 100% | 99% | 98% | 97% | 96% | 94% | 91% |
| Comparative | 100% | 100% | 99% | 97% | 94% | 90% | 85% | 78% |
| Example | | | | | | | | |

Table 2 shows the capacity maintenance rate in examples 1 to 3. The capacity maintenance rate was calculated when the number of charge-discharge cycles reached 0, 50, 100, 150, 200, 250, 300, and 350. In this case, the charge current value (A) was sequentially increased in the manner of 0, 210, 220, 230, 240, 250, 260, and 280. FIG. 12 shows the capacity maintenance rate with respect to the number of cycles. It can be understood that the decrease in the capacity maintenance rate in examples 1 to 3 was smaller than the comparative example even if the number of cycles increased.

In examples 1 to 3, the first projection 43 became inclined since it did not press the flat portion 31. Thus, the first projection 43 pressed the side wall with a greater binding pressure than the binding pressure applied by the second projections 44 to the side wall 11A. As a result, even if electrode contraction occurs around the upper curved portion 32, the inter-electrode distance can be maintained. This reduces lithium precipitation and limits decreases in the capacity maintenance rate.

### Advantages of the Embodiment

The advantages of the above embodiment are listed below.

(1) A slight amount of water passes through the sealing portion 12A of each the battery cell 10 and infiltrates the case 11 as time elapses. The infiltrating water reacts with the lithium ions around the upper curved portion 32 of the electrode body 20 near the sealing portion 12A. This extracts the lithium ions from the active material and cause contraction of the active material that leads to contraction of the electrode body 20. Such contraction will reduce the binding pressure applied by the spacer 40 to the upper curved portion 32. Thus, it will become difficult to maintain the inter-electrode distance, and the capacity maintenance rate may decrease.

In this respect, the first projection 43 presses the side wall 11A at a position corresponding to the upper curved portion 32. This increases the binding pressure at the pressed portion such that the displaced amount of the side wall 11A is greater than other regions. Thus, even if contraction of the electrode body 20 occurs, the inter-electrode distance can be maintained. As a result, lithium precipitation will be reduced, and decreases in the capacity maintenance rate will be limited.

(2) Even though there is a gap between the side walls 11A and the upper curved portion 32, the first projection 43 will become inclined since it will not press the flat portion 31. This will press the side wall 11A at the position corresponding to the upper curved portion 32 in a state in which load is concentrated and increased. As a result, the inter-electrode distance can be maintained even if contraction of the electrode body 20 occurs.

(3) The first projection 43 extends continuously in a seamless manner in a direction parallel to the upper edge of the flat portion 31. This will press the side wall 11A at the position corresponding to the upper curved portion 32 continuously in a seamless manner in the direction extending parallel to the upper edge of the flat portion 31.

(4) The projections 42 are equal in height from the base plate 41. This allows the flat side wall 11A to be entirely pressed by the first projection 43 and the second projections 44. Inclination of the first projection 43 will increase the binding pressure at the position corresponding to the upper curved portion 32 on the side wall 11A.

(5) Percentage C, which is the percentage of the distanced amount from the upper edge of the flat portion 31 to the position pressed by the first projection 43, is set to 4.5% or greater and 13.6% or less. This reduces lithium precipitation and limits decreases in the capacity maintenance rate.

### Modified Examples

The above embodiment may be modified as described below.

As long as the upper curved portion 32 can be pressed through the side wall 11A by the first projection 43, percentage C, which is the percentage of the distanced amount from the upper edge of the flat portion 31 to the position pressed by the first projection 43, does not have to be set to 4.5% or greater and 13.6% or less. Thus, percentage C may be less than 4.5% or greater than 13.6%.

The projections 42 do not have to be equal in height from the base plate 41. In one example, if the side walls 11A are flexible, the first projection 43 can be greater in height than the second projections 44. This allows the position corresponding to the upper curved portion 32 to be pressed with a higher binding pressure.

The first projection 43 does not have to be a rib that extends continuously in the direction in which the upper curved portion 32 extends. In one example, the first projection 43 may be a continuous rib that is partially interrupted. Further, the first projection 43 may be a rib that is broken at intervals in the direction in which the upper curved portion 32 extends.

The electrode body 20 does not have to be a roll and may a stack of the positive electrode sheet 21, the negative electrode sheet 24, and the separator 27 accommodated in the case 11. In this case, the electrode body 20 will not include the upper curved portion 32 and the lower curved portion 33. The first projection 43 will press the side wall 11A at a position corresponding to a location above the upper edge of the flat portion 31, and not press the flat portion 31.

The first projection 43 does not have to be only the uppermost projection 42 and may be the second or third projection 42 from the top as long as it extends at a position corresponding to the upper curved portion 32.

The projections 42 of the spacer 40 do not have to be structured as shown in FIGS. 5 and 6. In one example, the projections 42 may all have the same height and extend parallel to the rolling axis L1 at equal intervals. In a spacer 40 including projections extending sideward, when more than one projection extends at positions corresponding to the upper curved portion 32, such projections serve as the first projection 43. The remaining projections corresponding to the flat portion 31 serve as the second projections 44.

Further, the projections 42 may extend vertically orthogonal to the rolling axis L1 at equal intervals. In this case, the portions that press the side walls 11A at a position corresponding to the upper curved portion 32 serve as the first projection 43.

The first projection 43 does not have to be a flat surface and may be a single arcuate surface or an irregular surface including ridges and valleys. The end surface of each projection 42 may be an inclined surface inclined from one side to the other side. Further, the end surface of each projection 42 may be formed by a combination of these shapes.

The projections 42 do not have to be arranged at equal intervals. More specifically, some of the projections 42 may be arranged at narrowed or widened intervals.

The battery cell 10 is not limited to a lithium-ion rechargeable battery and may be a nickel-metal hydride rechargeable battery as long as it includes the positive electrode sheet 21, the negative electrode sheet 24, and a non-aqueous electrolyte.

The battery cell 10, which is a lithium-ion rechargeable battery, may be used in an automatic transporting vehicle, a special hauling vehicle, a battery electric vehicle, a hybrid electric vehicle, a computer, an electronic device, or any other system. For example, the battery cell 10 may be used in a marine vessel, an aircraft, or any other type of movable body. The battery cell 10 may also be used in a system that supplies electric power from a power plant via a substation to buildings and households.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A battery pack, comprising:
battery cells, each including an electrode body and a case accommodating the electrode body in a state sealed by a sealing portion, the battery cells being arranged next to one another in an arrangement direction that is a single direction; and
a spacer arranged between one of two side walls of the case of one of the battery cells and one of two side walls of the case of an adjacent one of the battery cells, wherein
the battery cells are bound together in a state in which a binding pressure acting to force the battery cells toward each other is applied to the battery cells,
the electrode body includes two opposing flat portions, each facing one of the side walls of the corresponding case,
the spacer includes a base plate and projections projecting from the base plate toward one of the side walls of the case of the one of the adjacent battery cells,
the projections include a top projection, and
the top projection presses the one of the side walls of the case of the one of the adjacent battery cells at a position located upward from an upper edge of each of the flat portions where the sealing portion is the closest.

2. The battery pack according to claim 1, wherein:
the electrode body is a flattened roll formed by rolling a stack of a positive electrode sheet, a negative electrode sheet, and a separator; the flattened roll includes two opposing surfaces that define the two opposing surfaces;
the flattened roll includes an upper curved portion bulged upward and connecting the upper edges of the two flat portions; and
the top projection presses the one of the side walls of the case of the one of the adjacent battery cells at a position corresponding to the upper curved portion.

3. The battery pack according to claim 1, wherein the top projection extends continuously in a seamless manner in a direction parallel to the upper edges of the flat portions.

4. The battery pack according to claim 1, wherein the projections are equal in height from the base plate.

5. The battery pack according to claim 1, wherein:
when A represents a length of the side wall of the case between a first position corresponding to the upper edge of each of the flat portions and a second position corresponding to a lower edge of each of the flat portions; and
B represents a distance from the first position to a position pressed by the top projection near the first position;
percentage C of B to A is 4.5% or greater and 13.6% or less.
